(19) United States
(12) Patent Application Publication
(10) Pub. No.: US 2023/0275268 A1
(43) Pub. Date: Aug. 31, 2023

(54) NONAQUEOUS ELECTROLYTE SECONDARY BATTERY POROUS LAYER

(71) Applicant: Sumitomo Chemical Company, Limited, Tokyo (JP)

(72) Inventors: Eri OKANISHI, Niihama-shi (JP); Kensaku HORIE, Niihama-shi (JP)

(21) Appl. No.: 18/114,917

(22) Filed: Feb. 27, 2023

(30) Foreign Application Priority Data
Feb. 28, 2022 (JP) 2022-029925

(51) Int. Cl. H01M 10/0565; H01M 50/417; H01M 50/491

(52) U.S. Cl. CPC H01M 10/0565; H01M 50/417; H01M 50/491

(57) ABSTRACT

Provided is a nonaqueous electrolyte secondary battery porous layer which can constitute a nonaqueous electrolyte secondary battery separator which achieves both heat resistance and improvement of a rate characteristic of a nonaqueous electrolyte secondary battery. The nonaqueous electrolyte secondary battery porous layer includes: a resin containing an amide bond; and a filler, and has a porosity of not less than 75%, the filler containing a filler A which has an average particle diameter of not more than 0.04 μm and a filler B which has an average particle diameter of not less than 0.1 μm.

This Nonprovisional application claims priority under 35 U.S.C. § 119 on Patent Application No. 2022-029925 filed in Japan on Feb. 28, 2022, the entire contents of which are hereby incorporated by reference.

### TECHNICAL FIELD

The present invention relates to a porous layer for nonaqueous electrolyte secondary batteries (hereinafter, referred to as “nonaqueous electrolyte secondary battery porous layer”).

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries have recently been developed as on-vehicle batteries.

In accordance with expansion of applications of nonaqueous electrolyte secondary batteries, in these days, a separator for batteries has been required to be heat-resistant in order to improve safety of a battery. Examples of a separator having an improved heat resistance include a separator for a secondary battery (secondary battery separator) constituted by a porous film which includes: a porous base; and a porous layer that is provided on at least one surface of the porous base and that contains inorganic particles and a heat-resistant resin (Patent Literature 1).

### CITATION LIST

### Patent Literature

[Patent Literature 1]
Pamphlet of International Publication No. WO 2018/155288

### SUMMARY OF INVENTION

### Technical Problem

It is generally known that in connection with a separator for a nonaqueous electrolyte secondary battery (hereinafter, referred to as “nonaqueous electrolyte secondary battery separator”), a rate characteristic of the nonaqueous electrolyte secondary battery and heat resistance are in a trade-off relationship. However, recently in the field of nonaqueous electrolyte secondary battery separators, it has been required to achieve both the heat resistance and improvement of the rate characteristic of the nonaqueous electrolyte secondary battery. This has been conventionally impossible.

A conventional separator such as the separator disclosed in Patent Literature 1 has room for improvement in rate characteristic of a nonaqueous electrolyte secondary battery including the separator. In fact, no separator achieving both the heat resistance and improvement of the rate characteristic has been provided.

It is an object of the present invention to provide a nonaqueous electrolyte secondary battery porous layer which can constitute a nonaqueous electrolyte secondary battery separator that achieves both heat resistance and improvement of a rate characteristic such as a rate capacity maintaining ratio of a nonaqueous electrolyte secondary battery.

### Solution to Problem

The present inventors found, as a result of diligent studies, that a separator including a porous layer containing two kinds of fillers which have different average particle diameters from each other can achieve both heat resistance and improvement of a rate characteristic of a nonaqueous electrolyte secondary battery. As a result, the present inventors have arrived at the present invention.

The present invention includes aspects described in <1> to <9> below.

<1> A nonaqueous electrolyte secondary battery porous layer including:
a resin containing an amide bond; and
a filler,
the nonaqueous electrolyte secondary battery porous layer having a porosity of not less than 75%,
the filler containing
   a filler A having an average particle diameter of not more than 0.04 μm, and
   a filler B having an average particle diameter of not less than 0.1 μm.

<2> The nonaqueous electrolyte secondary battery porous layer according to <1>, wherein the filler A is contained in an amount of not less than 10% by weight and the filler B is contained in an amount of not less than 30% by weight with respect to a total weight of the nonaqueous electrolyte secondary battery porous layer.

<3> The nonaqueous electrolyte secondary battery porous layer according to <1> or <2>, wherein the filler as a whole is contained in an amount of not less than 70% by weight with respect to a total weight of the nonaqueous electrolyte secondary battery porous layer.

<4> The nonaqueous electrolyte secondary battery porous layer according to any one of <1> to <3>, wherein the resin containing the amide bond includes aromatic polyamide.

<5> The nonaqueous electrolyte secondary battery porous layer according to <4>, wherein the aromatic polyamide is para-aromatic polyamide.

<6> The nonaqueous electrolyte secondary battery porous layer according to any one of <1> to <5>, wherein the filler contains a filler having a spherical shape.

<7> A nonaqueous electrolyte secondary battery separator including:
a porous film containing a polyolefin-based resin as a main component; and
the nonaqueous electrolyte secondary battery porous layer according to any one of <1> to <6> formed on one surface or both surfaces of the porous film.

<8> A member for a nonaqueous electrolyte secondary battery (hereinafter, referred to as “nonaqueous electrolyte secondary battery member”), the member comprising:
a positive electrode;
the nonaqueous electrolyte secondary battery porous layer according to <1> to <6> or the nonaqueous electrolyte secondary battery separator according to <7>; and
a negative electrode,
the positive electrode, the nonaqueous electrolyte secondary battery porous layer or the nonaqueous electrolyte secondary battery separator, and the negative electrode being disposed in this order.

<9> A nonaqueous electrolyte secondary battery comprising the nonaqueous electrolyte secondary battery porous layer according to any one of <1> to <6> or the nonaqueous electrolyte secondary battery separator according to <7>.

### Advantageous Effects of Invention

The nonaqueous electrolyte secondary battery porous layer in accordance with an embodiment of the present invention can advantageously constitute a nonaqueous electrolyte secondary battery separator that achieves both heat resistance and improvement of a rate characteristic such as a rate capacity maintaining ratio of a nonaqueous electrolyte secondary battery.

### DESCRIPTION OF EMBODIMENTS

The following description will discuss embodiments of the present invention. Note, however, that the present invention is not limited to these embodiments. The present invention is not limited to arrangements described below, but may be altered in various ways by a skilled person within the scope of the claims. The present invention also encompasses, in its technical scope, any embodiment derived by combining technical means disclosed in differing embodiments. Any numerical range expressed as “A to B” herein means “not less than A and not more than B” unless otherwise stated.

### Embodiment 1: Nonaqueous Electrolyte Secondary Battery Porous Layer

A nonaqueous electrolyte secondary battery porous layer (hereinafter, also referred to simply as “porous layer”) in accordance with an embodiment of the present invention includes: a resin containing an amide bond; and a filler and has a porosity of not less than 75%, the filler containing a filler A which has an average particle diameter of not more than 0.04 μm, and a filler B which has an average particle diameter of not less than 0.1 μm.

The porous layer, for example, in the form of an electrode coating layer, by itself can be a nonaqueous electrolyte secondary battery separator. Alternatively, the porous layer can be a member of the nonaqueous electrolyte secondary battery separator in accordance with an embodiment of the present invention when formed on a porous film described later.

The porous layer has a porosity of as high as not less than 75%. In view of heat resistance, the porosity has an upper limit value of preferably not more than 95%, more preferably not more than 80%, and still more preferably not more than 78%.

[Resin Containing Amide Bond]

The porous layer in accordance with an embodiment of the present invention contains a resin containing an amide bond. The resin containing the amide bond can serve as a binder resin that (i) binds particles of the filler together, (ii) binds the filler and a positive electrode or negative electrode to each other, or (iii) binds the filler and a porous film described later to each other.

In an embodiment of the present invention, the resin containing the amide bond is preferably insoluble in an electrolyte of a battery, and when the battery is in normal use, the resin is preferably electrochemically stable. In addition, the resin containing the amide bond is preferably a heat-resistant resin.

The resin containing the amide bond is not limited to a particular one. Specific examples of the resin containing the amide bond include a polyamide-based resin. Further, the resin containing the amide bond can be made of a single kind of resin or a mixture of two or more kinds of resins.

Examples of the polyamide-based resin include an aromatic polyamide. The polyamide-based resin is preferably a wholly aromatic polyamide (aramid resin).

In addition, the aromatic polyamide is preferably para-aromatic polyamide. The para-aromatic polyamide refers to an aromatic polyamide in which amide bonds each of which is bound to a para position of an aromatic ring account for not less than 80% of amide bonds in the aromatic polyamide. The para-aromatic polyamide has a low bendability, and thus is more excellent in heat resistance. Therefore, if the resin is a para-aromatic polyamide, the porous layer is more excellent in heat resistance.

Specific examples of the aromatic polyamide, particularly, specific examples of the aramid resin include a para-aramid and a meta-aramid. In the view of the above-described heat resistance, the para-aramid is preferable. Examples of the para-aramid include para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), a paraphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer.

The resin containing the amide bond has an intrinsic viscosity of preferably not more than 2.4 dL/g, and more preferably not more than 2.0 dL/g. In addition, the resin containing the amide bond has an intrinsic viscosity of preferably not less than 1.4 dL/g, and more preferably not less than 1.6 dL/g. When the intrinsic viscosity falls within the above preferable range, the step of forming a coating layer can be more easily carried out in a method (described later) for producing a porous layer. The intrinsic viscosity can be measured with use of a commercially available viscometer.

The porous layer may contain another resin other than the resin containing the amide bond. The other resin is not limited to a particular one. Examples of the other resin include: polyolefin-based resins; (meth)acrylate-based resins; fluorine-containing resins; polyimide-based resins; polyester-based resins; rubbers; resins each having a melting point or a glass transition temperature of not lower than 180° C.; and water-soluble polymers. The other resin may be made of a single kind of resin or a mixture of two or more kinds of resins.

Among the above specific examples, polyolefin-based resins, polyester-based resins, acrylate-based resins, fluorine-containing resins, and water-soluble polymers are preferable as the other resin. Of the polyester-based resins, polyarylates and liquid crystal polyesters are preferable. Of the fluorine-containing resins, polyvinylidene fluoride-based resin is preferable.

In an embodiment of the present invention, the porous layer contains the resin containing the amide bond in an amount of preferably not less than 10% by weight and not more than 30% by weight, and more preferably not less than 20% by weight and not more than 30% by weight with respect to the total weight of the porous layer.

[Filler]

The porous layer contains a filler. The filler contains a filler A which has an average particle diameter of not more than 0.04 μm and a filler B which has an average particle diameter of not less than 0.1 μm. The average particle diameter of the filler can be measured with use of a laser diffraction particle size analyzer (manufactured by Shimadzu Corporation, product name: SALD2200 etc.).

Since the porous layer contains the filler A that has a small average particle diameter and the filler B that has a large average particle diameter, the porous layer is provided with both fine pores each having a relatively small pore size and fine pores each having a relatively large pore size.

Accordingly, the porous layer has a high porosity and contains the fine pores each having a relatively large pore size. Thus, the porous layer makes it easy for an ion, which is a charge carrier, to pass through the porous layer in a nonaqueous electrolyte secondary battery. Therefore, the porous layer makes it possible to suitably improve a rate characteristic of the nonaqueous electrolyte secondary battery including the porous layer.

In addition, the porous layer has a high porosity and contains the fine pores each having a relatively small pore size. Therefore, the porous layer has a dense pore structure that is constituted by the fine pores each having the relatively small pore size. As a result, the porous layer has an excellent heat resistance.

In an embodiment of the present invention, preferably, the filler A is contained in an amount (hereinafter, also referred to as “filler A content”) of not less than 10% by weight and the filler B is contained in an amount (hereinafter, also referred to as “filler B content”) of not less than 30% by weight with respect to the total weight of the porous layer. More preferably, the filler A is contained in an amount of not less than 15% by weight and the filler B is contained in an amount of not less than 50% by weight with respect to the total weight of the porous layer.

When the filler A content and the filler B content with respect to the total weight of the porous layer fall within the above-described ranges, it is possible to generate, in the porous layer, the fine pores each having a relatively small pore size and the fine pores each having a relatively large pore size in a well-balanced manner. As a result, it is possible to suitably improve both the heat resistance of the porous layer and the rate characteristic of the nonaqueous electrolyte secondary battery including the porous layer in a well-balanced manner.

In an embodiment of the present invention, the filler may contain another filler that has a different average particle diameter from those of the filler A and the filler B. Meanwhile, if the porous layer having a porosity of not less than 75% excessively contains the other filler, the porous layer contains many fine pores each having a middle pore size between the relatively small pore size and the relatively large pore size.

Therefore, the other filler is contained in an amount (hereinafter, also referred to as “another filler content”) that is preferably as small as possible. The other filler content is preferably not more than 20% by weight, more preferably not more than 10% by weight, and still more preferably not more than 3% by weight with respect to the total weight of the filler. The filler particularly preferably consists of the filler A and the filler B, that is, the other filler content is particularly preferably 0% by weight.

In an embodiment of the present invention, preferably, the filler A content is not less than 10% by weight and the filler B content is not less than 50% by weight with respect to the total weight of the filler. More preferably, the filler A content is not less than 15% by weight and the filler B content is not less than 67% by weight with respect to the total weight of the filler.

When the filler A content and the filler B content with respect to the total weight of the filler fall within the above-described ranges, the other filler content described above is small, and it is possible to generate the fine pores each having a relatively small pore size and the fine pores each having a relatively large pore size in a well-balanced manner. As a result, it is possible to more suitably improve both the heat resistance of the porous layer and the rate characteristic of a nonaqueous electrolyte secondary battery including the porous layer in a well-balanced manner.

In an embodiment of the present invention, the porous layer contains the filler in an amount (hereinafter, also referred to as “filler content”) of preferably not less than 70% by weight, and more preferably not less than 75% by weight with respect to the total weight of the porous layer. In addition, the filler content is preferably not more than 90% by weight, and more preferably not more than 85% by weight with respect to the total weight of the porous layer.

When the filler content falls within the above-described range, it is possible to suitably control the porosity of the porous layer to not less than 75%. In addition, when the filler A content, the filler B content, the other filler content, and the filler content fall within the respective above-described ranges, it is possible to generate, as described above, the fine pores each having a relatively small pore size and the fine pores each having a relatively large pore size in a more well-balanced manner. As a result, it is possible to particularly suitably improve both the heat resistance of the porous layer and the rate characteristic of a nonaqueous electrolyte secondary battery.

In an embodiment of the present invention, a material of which the filler is made is not limited to a particular one. In addition, respective materials of which the filler A, the filler B, and the other filler are made may be the same. Alternatively, two of the respective materials may be the same. Still alternatively, each of the respective materials may be different from the other materials.

The filler may be an inorganic filler or an organic filler. Examples of the inorganic filler include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. Among the above examples, as the inorganic filler, a filler made of an inorganic oxide such as silica, calcium oxide, magnesium oxide, titanium oxide, alumina, mica, zeolite, aluminum hydroxide, or boehmite is preferable, and a filler made of calcium oxide, magnesium oxide, or alumina is more preferable, and a filler made of alumina is still more preferable. Examples of the organic filler include a filler made of resin.

The filler has a shape that is not limited to a particular one. Examples of the shape of the filler include a spherical shape, an elliptical shape, a plate shape, a bar shape, and an indefinite irregular shape. Among the above examples, the filler preferably has a spherical shape. When the filler has a spherical shape, the porous layer can be uniformly filled with the filler. In that case, it is considered that pores are more uniformly distributed in the porous layer, and this further improves the heat resistance of the porous layer.

[Physical Properties of Porous Layer]

The porous layer has a thickness of preferably 0.5 μm to 15 μm, and more preferably 1 μm to 10 μm. The thickness falling within the above-described range is suitable, for example, for reducing an internal short circuit due to breakage of a nonaqueous electrolyte secondary battery and/or the like, for retaining an electrolyte in the porous layer, and for reducing a decrease of the rate characteristic or a cycle characteristic.

A weight per unit area of the porous layer can be set as appropriate in view of strength, thickness, weight, and handleability of the porous layer. The weight per unit area of the porous layer is preferably 0.5 g/m² to 20 g/m² per porous layer, and more preferably 0.5 g/m² to 10 g/m² per porous layer. When the weight per unit area falls within the above-described numerical range, it is possible to allow a nonaqueous electrolyte secondary battery to have a high weight energy density and a high volume energy density.

The porous layer has an air permeability of preferably 2 sec/100 mL to 300 sec/100 mL in terms of Gurley values, and more preferably 5 sec/100 mL to 40 sec/100 mL in terms of Gurley values. When the air permeability of the porous layer falls within the above-described range, the porous layer can achieve sufficient ion permeability.

The porous layer has pores each having a pore size of preferably not more than 1.0 μm, and more preferably not more than 0.5 μm. When the pores each have such a size, a nonaqueous electrolyte secondary battery can achieve sufficient ion permeability.

The porous layer may contain a component other than the filler and the resin. Examples of the component include a surfactant and a wax. Further, the porous layer contains the component in an amount of preferably 0% by weight to 10% by weight with respect to the total weight of the porous layer.

[Method for Producing Porous Layer]

Examples of a method for producing the porous layer include a method in which after a coating liquid is prepared by dissolving the resin in a solvent and dispersing the filler in the solvent and then the coating liquid is applied on a base material, the solvent is removed, so that the porous layer is deposited. Note that the base material can be, for example, a porous film (described later) which constitutes a nonaqueous electrolyte secondary battery separator, or can be an electrode, particularly, a positive electrode, in a nonaqueous electrolyte secondary battery.

The solvent (dispersion medium) can be any solvent which (i) does not adversely influence the base materials such as the porous film and the electrode, (ii) allows the resin to be dissolved uniformly and stably, and (iii) allows the filler to be dispersed uniformly and stably. Specific examples of the solvent include: water; lower alcohols such as methyl alcohol, ethyl alcohol, n-propyl alcohol, isopropyl alcohol, and t-butyl alcohol; acetone; toluene; xylene; hexane; N-methylpyrrolidone; N,N-dimethylacetamide; and N,N-dimethylformamide. These solvents each can be used solely. Alternatively, two or more of the solvents can be used in combination.

The coating liquid can be prepared by any method, provided that the coating liquid can satisfy conditions, such as a resin solid content (resin concentration) and the amount of the filler, which are necessary to obtain a desired porous layer. Specific examples of the method for preparing the coating liquid include a mechanical stirring method, an ultrasonic dispersion method, a high-pressure dispersion method, and a media dispersion method. Further, the filler can be dispersed in the solvent with use of a conventionally and publicly known disperser such as a three-one motor. Further, the coating solution may contain, in addition to the resin and the filler, an additive(s) such as a disperser, a plasticizer, a surfactant, and/or a pH adjustor, provided that the additive does not prevent the object of an embodiment of the present invention from being attained.

The coating liquid can be applied to the base material by any method that is not limited to a particular one. For example, it is possible to employ (i) a sequential layer formation method in which a porous layer is formed on one surface of the base material and then another porous layer is formed on the other surface of the base material or (ii) a simultaneous layer formation method in which porous layers are formed in parallel on respective both surfaces of the base material.

The coating liquid can be applied to the base material or a support by any method that is not limited to a particular one, provided that the method can achieve a necessary weight per unit area and a necessary coating area. The method for applying the coating liquid can be, for example, a conventionally and publicly known method, such as a gravure coater method.

The solvent can be removed typically by drying. The drying can be carried out by any method which can sufficiently remove the solvent. Among methods for drying, in view of homogenization of an internal structure of the porous layer, the method for removing the solvent is preferably a drying method in which air is blown in a direction opposite to a direction in which a wet coating layer is transferred, a heating drying method by far infrared heating, or a freeze-drying. Further, the drying can be performed after the solvent contained in the coating liquid is replaced with another solvent.

### Embodiment 2: Nonaqueous Electrolyte Secondary Battery Separator

A nonaqueous electrolyte secondary battery separator in accordance with an embodiment of the present invention includes: a porous film that contains a polyolefin-based resin as a main component; and the nonaqueous electrolyte secondary battery porous layer in accordance with an embodiment of the present invention that is formed on one surface or both surfaces of the porous film. Hereinafter, the nonaqueous electrolyte secondary battery separator is also referred to simply as “separator”, and the above porous film is also referred to simply as “porous film”.

The separator including the porous layer in accordance with an embodiment of the present invention advantageously has a heat resistance that is excellent and allows a nonaqueous electrolyte secondary battery to have a rate characteristic, such as a rate capacity maintaining ratio, that is suitably improved.

[Porous Film]

The porous film contains a polyolefin-based resin as a main component. Here, the expression “contain a polyolefin-based resin as a main component” means that the polyolefin-based resin in the porous film accounts for not less than 50% by weight, preferably not less than 90% by weight, and more preferably not less than 95% by weight of the entire materials of which the porous film is made.

The porous film has therein many pores connected to one another. This allows a gas and a liquid to pass through the porous film from one surface to the other surface.

The porous film has a thickness of preferably 4 μm to 40 μm, and more preferably 5 μm to 20 μm. If the porous film has a thickness of not less than 4 μm, it is possible to sufficiently prevent an internal short circuit of a battery. In contrast, if the porous film has a thickness of not more than 40 μm, it is possible to prevent an increase in size of a nonaqueous electrolyte secondary battery.

The polyolefin-based resin preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000 because such a high molecular weight component improves the strength of a resultant porous film and a separator including the resultant porous film.

The polyolefin-based resin is not limited to a particular one. Examples of the polyolefin-based resin include thermoplastic resins such as a homopolymer or a copolymer each produced by polymerizing a monomer such as ethylene, propylene, 1-butene, 4-methyl-1-pentene, and 1-hexene. Examples of the homopolymer include polyethylene, polypropylene, and polybutene. Examples of the copolymer include an ethylene-propylene copolymer.

Among the above examples, polyethylene is preferable as the polyolefin-based resin because use of polyethylene makes it possible to prevent (shut down) a flow of an excessively large electric current into a separator at a lower temperature. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among the above examples, the ultra-high molecular weight polyethylene is more preferable.

A weight per unit area of the porous film can be determined as appropriate in view of strength, thickness, weight, and handleability of the porous film. Note, however, that the weight per unit area is preferably 4 g/m² to 20 g/m², more preferably 4 g/m² to 12 g/m², and still more preferably 5 g/m² to 10 g/m² in order to allow a nonaqueous electrolyte secondary battery to have a high weight energy density and a high volume energy density.

The porous film has an air permeability of preferably 30 sec/100 mL to 500 sec/100 mL in terms of Gurley values, and more preferably 50 sec/100 mL to 300 sec/100 mL in terms of Gurley values in order to achieve sufficient ion permeability.

The porous film has a porosity of preferably 20% by volume to 80% by volume, more preferably 30% by volume to 75% by volume, so as to (i) retain a larger amount of electrolyte and (ii) obtain the function of reliably preventing a flow of an excessively large electric current at a lower temperature. Further, in order to obtain sufficient ion permeability and prevent particles from entering the positive electrode and/or the negative electrode, the porous film has pores each having a pore size of preferably not more than 0.30 μm, more preferably not more than 0.14 μm.

[Method for Producing Porous Film]

A method for producing the porous film is not limited to a particular one. For example, the polyolefin porous film can be produced by a method as follows. First, polyolefin-based resin is kneaded together with a pore forming agent such as an inorganic bulking agent or a plasticizer, and optionally with another agent(s) such as an antioxidant. After kneading, the kneaded substances are extruded so as to produce a polyolefin resin composition in sheet form. The pore forming agent is then removed from the polyolefin resin composition in sheet form with use of a suitable solvent. After the pore forming agent is removed, the polyolefin resin composition is stretched so that a polyolefin porous film is obtained.

Examples of the inorganic bulking agent include an inorganic filler; one specific example of the inorganic bulking agent is calcium carbonate. Examples of the plasticizer include a low molecular weight hydrocarbon such as liquid paraffin.

[Physical Properties of Nonaqueous Electrolyte Secondary Battery Separator]

A separator in accordance with an embodiment of the present invention has a thickness of preferably 5.5 μm to 45 μm, and more preferably 6 μm to 25 μm.

The separator has an air permeability of preferably 100 sec/100 m to 350 sec/100 mL in terms of Gurley values, and more preferably 100 sec/100 mL to 300 sec/100 mL in terms of Gurley values.

The separator in accordance with an embodiment of the present invention may include, as necessary, another porous layer other than the porous film and the porous layer, provided that the other porous layer does not prevent an object of an embodiment of the present invention from being attained. Examples of the other porous layer encompass publicly known porous layers such as a heat-resistant layer, an adhesive layer, and a protective layer.

[Method for Producing Nonaqueous Electrolyte Secondary Battery Separator]

Examples of the method for producing the separator in accordance with an embodiment of the present invention include a method in which in the above-described method for producing the porous layer, the porous film is used as the base material.

### Embodiment 3: Nonaqueous Electrolyte Secondary Battery Member, and Embodiment 4: Nonaqueous Electrolyte Secondary Battery

A nonaqueous electrolyte secondary battery member in accordance with an embodiment of the present invention includes: a positive electrode; the porous layer in accordance with an embodiment of the present invention or the separator in accordance with an embodiment of the present invention; a negative electrode, the positive electrode, the porous layer or the separator, and the negative electrode being disposed in this order. In addition, the nonaqueous electrolyte secondary battery in accordance with an embodiment of the present invention includes the porous layer in accordance with an embodiment of the present invention or the separator in accordance with an embodiment of the present invention.

The nonaqueous electrolyte secondary battery member includes the porous layer, so that it is possible to advantageously have heat resistance that is excellent and allow a nonaqueous electrolyte secondary battery to have a rate characteristic such as a rate capacity maintaining ratio that is suitably improved. Including the porous layer, the nonaqueous electrolyte secondary battery advantageously has an excellent rate characteristic and an excellent heat resistance value.

The nonaqueous electrolyte secondary battery in accordance with an embodiment of the present invention can be produced by a conventionally and publicly known method. For example, the nonaqueous electrolyte secondary battery member is formed by providing a positive electrode, and the porous layer or the porous film on which the porous layer has been formed, and a negative electrode in this order. Here, if the porous layer is formed on the porous film, the porous layer is present between the porous film and the positive electrode and/or between the porous film and the negative electrode. Next, the nonaqueous electrolyte secondary battery member is put into a container, which is a housing of the nonaqueous electrolyte secondary battery. Subsequently, the container is filled with a nonaqueous electrolyte, and then is hermetically sealed while pressure is being reduced in the container. This makes it possible to produce the nonaqueous electrolyte secondary battery.

<Positive Electrode>

The positive electrode in an embodiment of the present invention is not limited to a particular one, provided that the positive electrode is one that is typically used for a positive electrode of a nonaqueous electrolyte secondary battery. Examples of the positive electrode include a positive electrode sheet having a structure in which an active material layer, containing a positive electrode active material and a binding agent, is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include lithium complex oxides each containing at least one selected from the group consisting of transition metals such as V, Mn, Fe, Co, and Ni.

Examples of the electrically conductive agent include at least one selected from the group consisting of, for example, carbonaceous materials such as natural graphite, artificial graphite, cokes, carbon black, pyrolytic carbons, carbon fiber, and a fired product of an organic polymer compound.

Examples of the binding agent include: fluorine-based resins such as polyvinylidene fluoride (PVDF); acrylic resin; and styrene butadiene rubber.

Examples of the positive electrode current collector include electric conductors such as Al, Ni, and stainless steel.

Examples of a method for producing the positive electrode sheet include a method in which the positive electrode active material, the electrically conductive agent, and the binding agent are pressure-molded on the positive electrode current collector.

<Negative Electrode>

The negative electrode in an embodiment of the present invention is not limited to a particular one, provided that the negative electrode is one that is typically used for a negative electrode in a nonaqueous electrolyte secondary battery. Examples of the negative electrode include a negative electrode sheet having a structure in which an active material layer, containing a negative electrode active material and a binding agent, is formed on a negative electrode current collector. The active material layer may further contain an electrically conductive agent.

Examples of the negative electrode active material include materials each capable of being doped with and dedoped of metal ions such as lithium ions or sodium ions. Examples of the materials include carbonaceous materials, such as natural graphite.

Examples of the negative electrode current collector include Cu, Ni and stainless steel.

Examples of a method for producing the negative electrode sheet include a method in which the negative electrode active material is pressure-molded on the negative electrode current collector.

<Nonaqueous Electrolyte>

The nonaqueous electrolyte in an embodiment of the present invention is not limited to a particular one, provided that the nonaqueous electrolyte is one that is typically used for a nonaqueous electrolyte in a nonaqueous electrolyte secondary battery. Examples of the nonaqueous electrolyte include a nonaqueous electrolyte which is prepared by dissolving a lithium salt in an organic solvent. Examples of the lithium salt include at least one selected from the group consisting of LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄ and the like.

Examples of the organic solvent to be contained in the nonaqueous electrolyte include at least one selected from the group consisting of, for example, carbonates, ethers, esters, nitriles, amides, carbamates, sulfur-containing compounds, fluorine-containing organic solvents each obtained by introducing a fluorine group into any of these organic solvents.

### EXAMPLES

The present invention will be described below in more detail with reference to Examples and Comparative Examples. Note, however, that the present invention is not limited to such Examples.

[Method for Measuring Various Physical Properties]

Various physical properties in Examples and Comparative Examples were measured by methods as follows.

(1) Intrinsic Viscosity

Respective intrinsic viscosities of resins were measured by a method described in (i) to (iii) below. Note that as the resins, aramid resins 1 and 2 were used which were synthesized in Synthesis Examples 1 and 2 described later.

(i) With regard to a solution in which 0.5 g of resin was dissolved in 100 mL of concentrated sulfuric acid (aqueous solution of H2504 (sulfuric acid solution) having an H2504 concentration of 96% by weight to 98% by weight), a flow time was measured, with use of an Ubbelohde capillary viscometer, at a temperature set to 30° C.

(ii) With regard to the concentrated sulfuric acid which is the same as that in (i) except that the resin was not dissolved, a flow time was measured with use of the Ubbelohde capillary viscometer, at a temperature set to 30° C.

(iii) With use of the flow times measured in (i) and (ii), the respective intrinsic viscosities of the resins were calculated by the following formula (1).

Intrinsic viscosity=1n(T/T₀)/C (unit: dL/g) (1)
T: a flow time (s) of the concentrated sulfuric acid solution of the aramid resin which was the flow time measured in (i).
T₀: a flow time (s) of the concentrated sulfuric acid which was the flow time measured in (ii).
C: a concentration (g/dL) of the aramid resin in the concentrated sulfuric acid solution of the aramid resin.

(2) Thickness

A thickness of a separator was measured with use of a high-precision digital measuring device manufactured by Mitutoyo Corporation. Further, a peel-off tape was affixed to a surface on which a porous layer was formed and which was of the separator, and then the peel-off tape was peeled off. This peeled off the porous layer from a porous film. A thickness of the porous film from which the porous layer had been peeled off was measured as in measurement of the thickness of the separator. In addition, a thickness of the porous layer was calculated by subtracting the thickness thus measured of the porous film (from which the porous layer had been peeled off) from the thickness thus measured of the separator.

(3) Weight Per Unit Area of Porous Layer

A sample, which was a square piece having a side of 8 cm, was cut out from the separator, and the weight W₁ [g] of the sample was measured. Further, a peel-off tape was affixed to a surface which was of the sample and on which the porous layer was formed, and then the peel-off tape was peeled off. This peeled off the porous layer from the porous film. The weight W₂ [g] of the porous film from which the porous layer had been peeled off was measured. With use of the values of W₁ and W₂ thus measured, a weight per unit area [g/m²] of the porous layer was calculated by the following formula (2).

Weight per unit area of porous layer=(W₁−W₂)/(0.08×0.08) (2)

(4) Air Permeability

Respective air permeabilities of the separator and the porous film were measured in conformity with JIS P8117 with use of a digital timer Gurley densometer (manufactured by YASUDA SEIKI SEISAKUSHO, LTD.). The air permeability of the porous layer was calculated by subtracting the air permeability of the porous film from the air permeability of the separator. The value obtained by dividing the air permeability of the porous layer by a weight per unit area of the porous layer was defined as “air permeability per weight per unit area” of the porous layer.

(5) Porosity of Porous Layer

Respective constituent materials of the porous layer are denoted as a, b, c . . . Respective mass compositions of the constituent materials are denoted as Wa, Wb, Wc . . . , Wn (% by weight). Respective real densities of the constituent materials are denoted as da, db, dc . . . , do (g/cm³). The thickness of the porous layer is denoted as t (cm). With use of these parameters, the porosity ε [%] of the porous layer is calculated by the following formula (3). Note that, hereinafter, each of the weights of the constituent materials in the sample is referred to as “weight of constituent material per 1 cm².”

Porosity ε of porous layer=[1−{(Wa/da+Wb/db+We/dc+ . . . +Wn/dn)/t}]×100 (3)

As the real density of a filler, employed was a density disclosed in product information on the filler which was used. As the real density of the resin, employed was a density disclosed in Non-Patent Literature 1 (Takashi Noma. “Aramidosenni no Tokutyou to Youto (Characteristics and Applications of Aramid)”, Special topic “Gouseisenni no Kaihatsu Doukou (Move in Development of Synthetic Fibers”). Senni to Kougyou (Fibers and Industries). p242.)

(7) Shape Retention Rate after Heating

The separator which had been cut out to have a size of length×width: 108 mm×54 mm was placed on a glass plate such that a surface on which the porous film was formed faced downward. Both lengthwise ends of the separator were fixed to the glass plate with use of a polyimide adhesive tape (manufactured by Nitto Denko Corporation). In this state, each of the both lengthwise ends was covered with the polyimide adhesive tape by 4 mm in a lengthwise direction. That is, the separator had a measurement part which was not covered with the polyimide adhesive tape and which had a length of 100 mm. In this state, the width (L₁) [mm] of a center portion of the separator was measured. The width (L₁) corresponds to the width of the separator that had been cut out. Therefore, L₁=54 mm.

Subsequently, the glass plate to which the separator had been fixed was left to stand in a heating oven that was set to have a temperature of 200° C., and the glass plate was heated for 5 minutes. Next, the glass plate was taken out from the heating oven, and then was left to stand so as to be cooled down to room temperature. The width (L₂) [mm] of the center portion of the separator was then measured.

L₁−L₂ was defined as “heat deformation amount.” The value obtained by L₂/L₁ was defined as “shape retention rate after heating.” It can be said that when the shape retention rate after heating is not less than 70%, the separator has an excellent heat resistance.

(8) Rate Test

<Preparation of Nonaqueous Electrolyte Secondary Battery for Testing>

With use of the separator obtained in each of Examples and Comparative Examples described later, a nonaqueous electrolyte secondary battery for testing was prepared through a method described in 1. to 4. below.

1. A positive electrode and a negative electrode were prepared. As the positive electrode, employed was an electrode hoop (JFE Techno-Research Corporation) having a thickness of 51 μm and a density of 2.95 g/cm³. Composition of a positive electrode active material was as follows. LiNi_{0.8}Co_{0.15}Al_{0.05}O₂: 92 parts by weight, an electrically conductive agent: 4 parts by weight, and a binding agent: 4 parts by weight. As the negative electrode, employed was an electrode hoop (JFE Techno-Research Corporation) having a thickness of 59 μm and a density of 1.45 g/cm³. Composition of a negative electrode active material was as follows. Artificial graphite: 96.5 parts by weight, binding agent: 2 parts by weight, and carboxymethyl cellulose: 1.5 parts by weight.

2. A nonaqueous electrolyte secondary battery member was prepared by forming the positive electrode, a separator, and the negative electrode on top of each other in this order in a laminate pouch. In this state, the separator was disposed such that (a) the porous layer of the separator was in contact with the positive electrode active material of the positive electrode, and (b) the porous film of the separator was in contact with the negative electrode active material of the negative electrode.

3. The nonaqueous electrolyte secondary battery member prepared in 2. was stored in a bag made up of an aluminum layer and a heat-sealing layer that were formed on top of each other, and 230 μL of nonaqueous electrolyte was injected into the bag. The nonaqueous electrolyte was obtained by dissolving, in a mixed solvent, vinylene carbonate and LiPF₆ so that a vinylene carbonate concentration could be 1% by weight and an LiPF₆ concentration could be 1 mol/L. The mixed solvent was a solvent made of ethylene carbonate, ethyl methyl carbonate, and diethyl carbonate which were mixed at a volume ratio of 3:5:2.

4. While pressure was being reduced inside the bag into which the nonaqueous electrolyte secondary battery member and the nonaqueous electrolyte had been put in 3. above, the bag was heat-sealed. As a result, the nonaqueous electrolyte secondary battery for testing was prepared.

<Measurement of Rate Discharge Capacity Retention Rate>

The nonaqueous electrolyte secondary battery for testing was subjected to one cycle of initial charge and discharge. The initial charge and discharge were carried out (i) at 25° C., (ii) at a voltage ranging from 2.7 V to 4.2 V, and (iii) at electric current values of 0.1 C (charge) and 0.2 C (discharge). Note that 1 C refers to an electric current value at which a rated capacity defined as a one-hour discharge capacity is discharged in 1 hour. The same applies to the following description.

After the initial charge and discharge, 10 cycles of charge and discharge were carried out at electric current values of 1 C (charge) and 5 C (discharge), so that aging was carried out.

With respect to the nonaqueous electrolyte secondary battery which had been subjected to the aging, 9 cycles of charge and discharge were carried out at 25° C. under the conditions as follows. Charge current value: 1.0 C, end-of-charge voltage: 2.7V, and discharge current values: 0.2 C, 1 C, 2 C, 3 C, 4 C, 5 C, 6 C, 7 C, and 0.2 C. During the cycles of the charge and discharge, a charge capacity (mAh) and a discharge capacity (mAh) were measured under each of the conditions. With use of the discharge capacity at a first charge and discharge (0.2 C) and the discharge capacity at charge and discharge at a discharge current value of 4 C, a rate discharge capacity retention rate (%) was calculated by the following formula (4).

Rate discharge capacity retention rate (%)={discharge capacity (mAh) at 4 C/discharge capacity (mAh) at first charge and discharge (discharge capacity at 0.2 C)}×100 . . . (4)

### Synthesis of Aramid Resins

Poly(paraphenylene terephthalamide) corresponding to aramid resin was synthesized through each of methods described in Synthesis Examples 1 and 2 below. In addition, as a real density of the aramid resins thus synthesized, employed was 1.44 g/cm² which was disclosed in Non-Patent Literature 1 above.

### Synthesis Example 1

As a vessel for synthesis, employed was a separable flask which had a capacity of 3 L and which had a stirring blade, a thermometer, a nitrogen inlet pipe, and a powder addition port. Into the separable flask which had been sufficiently dried, 2200 g of N-methyl-2-pyrrolidone (NMP) was introduced. Further, into this flask, 151.07 g of calcium chloride powder was added, and the temperature was raised to 100° C., so that the calcium chloride powder was completely dissolved. The calcium chloride powder had been vacuum-dried at 200° C. for 2 hours in advance.

Subsequently, a temperature (solution temperature) of the solution in the separable flask was cooled down to room temperature, and 68.23 g of paraphenylenediamine was added. The paraphenylenediamine was then completely dissolved, so that a solution A was obtained. After that, while the temperature (solution temperature) of the solution A was maintained at 20° C.±2° C., 124.97 g of terephthalic acid dichloride was added to the solution A in four separate portions at approximately 10-minute intervals. This gave a solution B. Thereafter, while the solution B was being stirred at 150 rpm, the solution B was matured for one hour in a state in which the temperature of the solution B was maintained at 20° C.±2° C. This gave an aramid polymerization solution (1). The aramid polymerization solution (1) contained, in an amount of 6% by weight, the poly(paraphenylene terephthalamide) corresponding to aramid resin. The poly(paraphenylene terephthalamide) contained in the aramid polymerization solution (1) is referred to as “aramid resin 1”. The aramid resin 1 had an intrinsic viscosity of 1.9 g/dL.

### Synthesis Example 2

An aramid polymerization solution (2) was obtained as in Synthesis Example 1, except that the amount of the terephthalic acid dichloride added was changed to 124.61 g. The aramid polymerization solution (2) contained the poly(paraphenylene terephthalamide) in an amount of 6% by weight. The poly(paraphenylene terephthalamide) contained in the aramid polymerization solution (2) is referred to as “aramid resin 2”. The aramid resin 2 had an intrinsic viscosity of 1.7 g/dL.

### Example 1

<Preparation of Coating Liquid>

A solution C(1) was prepared by adding a small-particle-sized filler and a large-particle-sized filler to the aramid polymerization solution (1) so that a weight ratio of aramid resin 1:small-particle-sized filler:large-particle-sized filler could be 20:20:60. The small-particle-sized filler was made of Alumina C manufactured by Nippon Aerosil Co., Ltd., and had an average particle diameter of 0.02 μm and a real density of 3.27 g/cm³. The large-particle-sized filler was made of AKP-3000 manufactured by Sumitomo Chemical Co., Ltd., and had an average particle diameter of 0.7 μm and a real density of 3.97 g/cm³. Next, to the solution C(1), NMP was added and was diluted. As a result, prepared was a coating liquid (1) in which a total concentration of the aramid resin 1 and the filler, that is, the solid content concentration was 6% by weight.

<Preparation of Nonaqueous Electrolyte Secondary Battery Laminated Separator>

The coating liquid (1) was applied to a porous film through a doctor blade method, so that a coated product (1) was obtained. The porous film was made of polyethylene, and had a thickness of 10.6 μm, a porosity of 42%, an air permeability of 173 sec/100 mL, and a weight per unit area of 6.0 g/m². Subsequently, the coated product (1) was left to stand for 1 minute in air at 50° C. and at a relative humidity of 70%, so that the aramid resin 1 was deposited on the porous film. After that, the coated product (1) on which the aramid resin 1 had been deposited was immersed in ion exchange water, so that calcium chloride and a solvent were removed from the coated product (1). Further, the coated product (1) was dried with use of an oven at 80° C., so that a porous layer (1) was formed on the porous film. This provided a separator (1). Tables 1 and 2 show physical properties of the separator (1).

### Example 2

A solution C(2) was prepared by adding the small-particle-sized filler and the large-particle-sized filler to the aramid polymerization solution (1) so that a weight ratio of aramid resin 1:small-particle-sized filler:large-particle-sized filler could be 10:10:80. A separator (2) was obtained by forming a porous layer (2) on the porous film as in Example 1 except that the solution C(2) was used instead of the solution C(1). Tables 1 and 2 show physical properties of the separator (2).

### Example 3

A solution C(3) was prepared by adding the small-particle-sized filler and the large-particle-sized filler to the aramid polymerization solution (1) so that a weight ratio of aramid resin 1:small-particle-sized filler:large-particle-sized filler could be 15:15:70. A separator (3) was obtained by forming a porous layer (3) on the porous film as in Example 1 except that the solution C(3) was used instead of the solution C(1). Tables 1 and 2 show physical properties of the separator (3).

### Example 4

A solution C(4) was prepared by adding the small-particle-sized filler and the large-particle-sized filler to the aramid polymerization solution (1) so that a weight ratio of aramid resin 1:small-particle-sized filler:large-particle-sized filler could be 25:25:50. A separator (4) was obtained by forming a porous layer (4) on the porous film as in Example 1 except that the solution C(4) was used instead of the solution C(1). Tables 1 and 2 show physical properties of the separator (4).

### Comparative Example 1

A comparative solution C(1) was prepared by adding the small-particle-sized filler and the large-particle-sized filler to the aramid polymerization solution (1) so that a weight ratio of aramid resin 1:small-particle-sized filler:large-particle-sized filler could be 33:33:34. A comparative separator (1) was obtained by forming a comparative porous layer (1) on the porous film as in Example 1 except that the comparative solution C(1) was used instead of the solution C(1). Tables 1 and 2 show physical properties of the comparative separator (1).

### Comparative Example 2

A comparative solution C(2) was prepared by adding the large-particle-sized filler to the aramid polymerization solution (1) so that a weight ratio of aramid resin 1:small-particle-sized filler:large-particle-sized filler could be 20:0:80. A comparative separator (2) was obtained by forming a comparative porous layer (2) on the porous film as in Example 1 except that the comparative solution C(2) was used instead of the solution C(1).

### Comparative Example 3

The aramid polymerization solution (2) was used instead of the aramid polymerization solution (1). A comparative solution C(3) was prepared by adding the small-particle-sized filler to the aramid polymerization solution (2) so that a weight ratio of aramid resin 2:small-particle-sized filler:large-particle-sized filler could be 50:50:0. A comparative separator (3) was obtained by forming a comparative porous layer (3) on the porous film as in Example 1 except that the comparative solution C(3) was used instead of the solution C(1). Tables 1 and 2 show physical properties of the comparative separator (3).

### Comparative Example 4

To 4180 g of NMP, 320 g of calcium chloride and 500 g of poly(metaphenylene terephthalamide) (manufactured by Sigma-Aldrich) were added, so that a solution of poly(metaphenylene terephthalamide) whose concentration was 10% by weight was prepared. Hereinafter, the poly(metaphenylene terephthalamide) is referred to as “aramid resin 3”. Note that a real density of the aramid resin 3 was 1.38 g/cm³ as disclosed in Non-Patent Literature 1.

The solution of the poly(metaphenylene terephthalamide) was used instead of the aramid polymerization solution (1). A comparative solution C(4) was prepared by adding the small-particle-sized filler and the large-particle-sized filler to the solution of the poly(metaphenylene terephthalamide) so that a weight ratio of aramid resin 3:small-particle-sized filler:large-particle-sized filler could be 10:10:80. A comparative separator (4) was obtained by forming a comparative porous layer (4) on the porous film as in Example 1 except that the comparative solution C(4) was used instead of the solution C(1). Tables 1 and 2 show physical properties of the comparative separator (4).

### Comparative Example 5

The solution (prepared in Comparative Example 4) of the poly(metaphenylene terephthalamide) was used instead of the aramid polymerization solution (1). A comparative solution C(5) was prepared by adding the large-particle-sized filler to the solution of the poly(metaphenylene terephthalamide) so that a weight ratio of aramid resin 3:small-particle-sized filler:large-particle-sized filler could be 20:0:80. A comparative separator (5) was obtained by forming a comparative porous layer (5) on the porous film as in Example 1 except that the comparative solution C(5) was used instead of the solution C(1). Tables 1 and 2 show physical properties of the comparative separator (5).

### Comparative Example 6

As the large-particle-sized filler, employed was boehmite (manufactured by Anhui Estone Materials technology; product name: BG-611; average particle diameter: 0.7 μm, and real density: 3.05 g/cm³), which was a large-particle-sized filler having a plate shape. A comparative solution C(6) was prepared by adding the large-particle-sized filler having a plate shape to the aramid polymerization solution (1) so that a weight ratio of aramid resin 1:small-particle-sized filler:large-particle-sized filler having a plate shape could be 20:0:80. A comparative separator (6) was obtained by forming a comparative porous layer (6) on the porous film as in Example 1 except that the comparative solution C(6) was used instead of the solution C(1). Tables 1 and 2 show physical properties of the comparative separator (6).

### Synthesis Example 3

<Preparation of Aramid Polymerization Solution>

An aramid polymerization solution was prepared by a method including the steps described in (a) to (g) below.

(a) A separable flask was sufficiently dried. The separable flask had a capacity of 5 L and had a stirring blade, a thermometer, a nitrogen inlet pipe, and a powder addition port.

(b) Into the separable flask, 4177 g of NMP was introduced. Further, into this flask, 366.29 g of calcium chloride (which had been dried for two hours at 200° C.) was added, and the temperature was raised to 100° C., so that the calcium chloride was completely dissolved. This gave a solution of the calcium chloride. Here, the solution of the calcium chloride was prepared so as to have a calcium chloride concentration of 8.00% by weight and a water content of 300 ppm.

(c) While the temperature of the solution of the calcium chloride was maintained at 100° C., 141.119 g of 4,4′-diaminodiphenylsulfone (DDS) was added to the solution of the calcium chloride, and the DDS was completely dissolved, so that a solution 1 was obtained.

(d) The solution 1 thus obtained was cooled to 20° C. Then, while the temperature of the solution 1 thus cooled was maintained at 25±5° C., 226.911 g in total of terephthalic acid dichloride (TPC) was added, to the solution 1, in three separate portions and was reacted with the DDS for 1 hour, so that a reaction solution 1 was obtained. In the reaction solution 1, a block 1 made of poly(4,4′-diphenylsulfonyl terephthalamide) was prepared.

(e) To the reaction solution 1 thus obtained, 61.460 g of paraphenylenediamine (PPD) was added, and the PPD was completely dissolved over 1 hour, so that a solution 2 was obtained.

(f) While the temperature of the solution 2 was maintained at 25±2° C., 123.059 g in total of TPC was added, to the solution 2, in three separate portions and was reacted, for 1.5 hours, with a reaction product of the PPD and the block 1, so that a reaction solution 2 was obtained. In the reaction solution 2, a block 2 made of poly(paraphenylene terephthalamide) extended on both sides of the block 1.

(g) The reaction solution 2 was matured for 1 hour while the temperature of the reaction solution 2 was maintained at 20±2° C. The reaction solution 2 was then stirred for 1 hour under a reduced pressure so that air bubbles were removed. This gave a solution (aramid polymerization solution (3)) containing a block copolymer in which the block 1 accounted for 50% of a whole molecule and the block 2 accounted for the other 50% of the whole molecule. The block copolymer was a resin including an amide bond. The block copolymer was regarded as an aramid resin 4. The aramid resin 4 had an intrinsic viscosity of 1.57 dL/g.

### Example 5

<Preparation of Coating Liquid>

A solution C(5) was prepared by adding a small-particle-sized filler and a large-particle-sized filler to the aramid polymerization solution (3) so that a weight ratio of aramid resin 4:small-particle-sized filler:large-particle-sized filler could be 20:20:60. The small-particle-sized filler was made of Alumina C manufactured by Nippon Aerosil Co., Ltd., and had an average particle diameter of 0.02 μm and a real density of 3.27 g/cm³. The large-particle-sized filler was made of AKP-3000 manufactured by Sumitomo Chemical Co., Ltd., and had an average particle diameter of 0.7 μm and a real density of 3.97 g/cm³. Next, NMP was added to the solution C(5), and the solution C(5) was diluted. As a result, prepared was a coating liquid (5) in which a total concentration of the aramid resin 4 and the filler, that is, the solid content concentration was 6% by weight.

<Preparation of Nonaqueous Electrolyte Secondary Battery Laminated Separator>

The coating liquid (5) was applied to a porous film through a doctor blade method, so that a coated product (5) was obtained. The porous film was made of polyethylene and had a thickness of 10.6 μm, a porosity of 42%, an air permeability of 173 sec/100 mL, and a weight per unit area of 6.0 g/m². Subsequently, the coated product (5) was left to stand for 1 minute in air at 50° C. and at a relative humidity of 70%, so that the aramid resin 4 was deposited on the porous film. After that, the coated product (5) on which the aramid resin 4 had been deposited was immersed in ion exchange water, so that calcium chloride and a solvent were removed from the coated product (5). Further, the coated product (5) was dried with use of an oven at 80° C., so that a porous layer (5) was formed on the porous film. This provided a separator (5). Tables 3 and 4 show physical properties of the separator (5).

### Example 6

A solution C(6) was prepared by adding the small-particle-sized filler and the large-particle-sized filler to the aramid polymerization solution (3) so that a weight ratio of aramid resin 4:small-particle-sized filler:large-particle-sized filler could be 25:25:50. A porous layer (6) was formed on the porous film as in Example 5 except that the solution C(6) was used instead of the solution C(5). A separator (6) was thus obtained. Tables 3 and 4 show physical properties of the separator (6).

### Comparative Example 7

A comparative solution C(7) was prepared by adding the small-particle-sized filler to the aramid polymerization solution (3) so that a weight ratio of aramid resin 4:small-particle-sized filler:large-particle-sized filler could be 50:50:0. A comparative porous layer (7) was formed on the porous film as in Example 5 except that the comparative solution C(7) was used instead of the solution C(5). A comparative separator (7) was thus obtained. Tables 3 and 4 show physical properties of the comparative separator (7).

[Result]

TABLE 1

| | Porous layer | | | | | | |
|---|---|---|---|---|---|---|---|
| | | | | | Air | | |
| | | | | | permeability | | |
| | | | Weight | | per weight | Separator | |
| | | | per unit | Air | per unit area | | Air |
| | Aramid | Thickness | area | permeability | [sec · m²/ | Thickness | permeability |
| | resin | [μm] | [g/m²] | [sec/100 mL] | 100 mL · g] | [μm] | [sec/100 mL] |
| Example 1 | 1 | 5.9 | 4.1 | 46 | 11 | 16.8 | 219 |
| Example 2 | 1 | 5.9 | 4.1 | 11 | 3 | 16.8 | 184 |
| Example 3 | 1 | 5.1 | 3.5 | 12 | 3 | 16.0 | 185 |
| Example 4 | 1 | 5.4 | 3.5 | 33 | 9 | 16.3 | 206 |
| Comparative | 1 | 5.3 | 3.6 | 74 | 21 | 16.2 | 247 |
| Example 1 | | | | | | | |
| Comparative | 1 | 6.6 | 4.2 | 62 | 15 | 17.5 | 235 |
| Example 2 | | | | | | | |
| Comparative | 2 | 5.7 | 3.9 | 189 | 48 | 16.6 | 362 |
| Example 3 | | | | | | | |
| Comparative | 3 | 3.0 | 2.6 | 13 | 5 | 14.3 | 186 |
| Example 4 | | | | | | | |
| Comparative | 3 | 5.9 | 4.6 | 16 | 3 | 17.3 | 189 |
| Example 5 | | | | | | | |
| Comparative | 1 | 6.2 | 4.1 | 49 | 12 | 17.8 | 222 |
| Example 6 | | | | | | | |

TABLE 2

| | | | | | | | Nonaqueous |
|---|---|---|---|---|---|---|---|
| | | | | | | | electrolyte |
| | Porous layer | | | | | Separator | secondary battery |
| | | Small-particle- | Large-particle- | | | Shape retention | Rate discharge |
| | Resin | sized filler | sized filler | Total filler | | rate after | capacity |
| | content | content | content | content | Porosity | heating | retention rate |
| | [% by weight] | [% by weight] | [% by weight] | [% by weight] | [%] | [%] | [%] |
| Example 1 | 20 | 20 | 60 | 80 | 75.7 | 83.7 | 51 |
| Example 2 | 10 | 10 | 80 | 90 | 79.2 | 76.6 | 52 |
| Example 3 | 15 | 15 | 70 | 85 | 77.5 | 74.8 | 54 |
| Example 4 | 25 | 25 | 50 | 75 | 75.5 | 85.5 | 53 |
| Comparative | 33 | 33 | 34 | 67 | 71.8 | 83.6 | 47 |
| Example 1 | | | | | | | |
| Comparative | 20 | 0 | 80 | 80 | 78.5 | 64.9 | 47 |
| Example 2 | | | | | | | |
| Comparative | 50 | 50 | 0 | 50 | 65.8 | 89.2 | 48 |
| Example 3 | | | | | | | |
| Comparative | 10 | 10 | 80 | 90 | 73.6 | Breakage | — |
| Example 4 | | | | | | | |
| Comparative | 20 | 0 | 80 | 80 | 73.0 | Breakage | — |
| Example 5 | | | | | | | |
| Comparative | 20 | 0 | 80 | 80 | 73.5 | 67.2 | — |
| Example 6 | | | | | | | |

TABLE 3

| | Porous layer | | | | | | |
|---|---|---|---|---|---|---|---|
| | | | | | Air | | |
| | | | | | permeability | | |
| | | | | | per weight | Separator | |
| | | | Weight per | Air | per unit area | | Air |
| | Aramid | Thickness | unit area | permeability | [sec · m²/ | Thickness | permeability |
| | resin | [μm] | [g/m²] | [sec/100 mL] | 100 mL · g] | [μm] | [sec/100 mL] |
| Example 5 | 4 | 7.1 | 3.1 | 11 | 3.6 | 18.4 | 193 |
| Example 6 | 4 | 6.0 | 3.2 | 21 | 6.5 | 16.9 | 200 |
| Comparative | 4 | 3.9 | 2.9 | 250 | 20.8 | 14.6 | 250 |
| Example 7 | | | | | | | |

TABLE 4

| | | | | | | | Nonaqueous |
|---|---|---|---|---|---|---|---|
| | | | | | | | electrolyte |
| | Porous layer | | | | | Separator | secondary battery |
| | | Small-particle- | Large-particle- | | | Shape retention | Rate discharge |
| | | sized filler | sized filler | Total filler | | rate after | capacity |
| | Resin content | content | content | content | Porosity | heating | retention rate |
| | [% by weight] | [% by weight] | [% by weight] | [% by weight] | [%] | [%] | [%] |
| Example 5 | 20 | 20 | 60 | 80 | 84.3 | 70.6 | 49 |
| Example 6 | 25 | 25 | 50 | 75 | 80.2 | 79.5 | 49 |
| Comparative | 50 | 50 | 0 | 50 | 65.9 | 85.2 | 45 |
| Example 7 | | | | | | | |

The comparative separators (4) and (5) which were described in Comparative Examples 4 and 5 had low heat resistances and therefore broke due to heating at measurement of the shape retention rate after heating. The expression “breakage” in Table 2 means a failure to measure the “shape retention rate after heating” due to the breakage of the comparative separators (4) and (5). The expression “-” in Table 2 means “no data”.

As shown in Table 2, each of the porous layers (1) to (4) described in Examples 1 to 4 corresponds to the porous layer in accordance with an embodiment of the present invention. The porous layer in accordance with an embodiment of the present invention has a porosity of not less than 75% and includes a small-particle-sized filler having an average particle diameter of not more than 0.04 μm and a large-particle-sized filler having an average particle diameter of not less than 0.1 μm. In contrast, each of the comparative porous layers (1) to (6) described in Comparative Examples 1 to 6 (i) has a porosity of lower than 75% and/or (ii) is in shortage of the small-particle-sized filler or the large-particle-sized filler. As compared with the separators described in Comparative Examples 1 to 6, each of the separators described in Examples 1 to 4 has high values for not only a shape retention rate after heating but also for a rate discharge capacity retention rate of a nonaqueous electrolyte secondary battery including the separator.

As shown in Table 4, the porous layers (5) and (6) described in Examples 5 and 6 each containing the aramid resin 4 correspond to the porous layer in accordance with an embodiment of the present invention that has a porosity of not less than 75% and that contains a small-particle-sized filler having an average particle diameter of not more than 0.04 μm and a large-particle-sized filler having an average particle diameter of not less than 0.1 μm. In contrast, the comparative porous layer (7) described in Comparative Example 7 containing the aramid resin 4 has a porosity of less than 75% and does not contain the large-particle-sized filler. Each of the separators described in Examples 5 and 6 could achieve high values for both the shape retention rate after heating and the rate discharge capacity retention rate of a nonaqueous electrolyte secondary battery including the separator. In contrast, the separator described in Comparative Example 7 was excellent in the shape retention rate after heating, but was poor in the rate discharge capacity retention rate of a nonaqueous electrolyte secondary battery including the separator.

Note that a person skilled in the art would understand that a one-percent difference in rate capacity maintaining ratio is technically remarkable.

As described above, it has been found that the porous layer in accordance with an embodiment of the present invention makes it possible to produce a nonaqueous electrolyte secondary battery separator that achieves both heat resistance and improvement of a rate characteristic such as a rate capacity maintaining ratio of a nonaqueous electrolyte secondary battery.

### INDUSTRIAL APPLICABILITY

The porous layer in accordance with an embodiment of the present invention can be used for production of a nonaqueous electrolyte secondary battery which achieves both an excellent rate characteristic and an excellent heat resistance.

1. A nonaqueous electrolyte secondary battery porous layer including:
a resin containing an amide bond; and
a filler,
the nonaqueous electrolyte secondary battery porous layer having a porosity of not less than 75%, and
the filler containing
a filler A having an average particle diameter of not more than 0.04 μm, and
a filler B having an average particle diameter of not less than 0.1 μm.

2. The nonaqueous electrolyte secondary battery porous layer according to claim 1, wherein
the filler A is contained in an amount of not less than 10% by weight and the filler B is contained in an amount of not less than 30% by weight with respect to a total weight of the nonaqueous electrolyte secondary battery porous layer.

3. The nonaqueous electrolyte secondary battery porous layer according to claim 1, wherein
the filler is contained in an amount of not less than 70% by weight with respect to a total weight of the nonaqueous electrolyte secondary battery porous layer.

4. The nonaqueous electrolyte secondary battery porous layer according to claim 1, wherein
the resin containing the amide bond includes aromatic polyamide.

5. The nonaqueous electrolyte secondary battery porous layer according to claim 4, wherein
the aromatic polyamide is para-aromatic polyamide.

6. The nonaqueous electrolyte secondary battery porous layer according to claim 1, wherein
the filler contains a filler having a spherical shape.

7. A nonaqueous electrolyte secondary battery separator comprising:
a porous film containing a polyolefin-based resin as a main component; and
the nonaqueous electrolyte secondary battery porous layer according to claim 1 formed on one surface or both surfaces of the porous film.

8. A nonaqueous electrolyte secondary battery member comprising:
a positive electrode;
the nonaqueous electrolyte secondary battery porous layer according to claim 1; and
a negative electrode,
the positive electrode, the nonaqueous electrolyte secondary battery porous layer, and the negative electrode being disposed in this order.

9. A nonaqueous electrolyte secondary battery member comprising:
a positive electrode;
the nonaqueous electrolyte secondary battery separator according to claim 7; and
a negative electrode,
the positive electrode, the nonaqueous electrolyte secondary battery separator, and the negative electrode being disposed in this order.

10. A nonaqueous electrolyte secondary battery comprising the nonaqueous electrolyte secondary battery porous layer according to claim 1.

11. A nonaqueous electrolyte secondary battery comprising the nonaqueous electrolyte secondary battery separator according to claim 7.
